(19) United States
(12) Patent Application Publication
(10) Pub. No.: US 2022/0108366 A1
(43) Pub. Date: Apr. 7, 2022

(54) DYNAMIC CONTENT ENRICHMENT

(71) Applicant: PAYPAL, INC., San Jose, CA (US)

(72) Inventor: Rahul Nair, Leander, TX (US)

(21) Appl. No.: 17/064,162

(22) Filed: Oct. 6, 2020

(51) Int. Cl. G06Q 30/06; G06F 40/35; G06F 16/9538

(52) U.S. Cl. CPC G06Q 30/0601; H04L 51/02; G06F 16/9538; G06F 40/35

(57) ABSTRACT

Methods and systems are presented for automatically and continuously enriching primary contents based on third-party contents. Third-party contents that are relevant to topics associated with the primary contents are retrieved from various content servers. The third-party contents may be analyzed, relevant portions thereof may be extracted. Different portions of the third-party contents may be combined to generate composite content items. The portions of the third-party contents and/or the composite content items may be integrated into different sections of the primary contents. The effectiveness of the integrated contents may be evaluated, and third-party contents that is less effective may be replaced with third-party contents that are more effective in the integrated contents.

### BACKGROUND

The present specification generally relates to enrichment of electronic content, and more specifically, to compiling and integrating electronic content of different types according to various embodiments of the disclosure.

### RELATED ART

Organizations that offer products (e.g., physical goods or services) to users often face a large amount of inquiries from their users. Different users may run into different issues when using the products offered by an organization, such as when the products are not operating as expected or desired, or when the user has questions about the operating process of the products, etc. Traditionally, the users may contact the organizations via any communication means, such as phone calls, e-mails, letters, to make such inquiries, and human resources (e.g., agents, customer service representatives, etc.) are provided by the organizations to provide answers or other information to the users.

A common way to improve cost efficiency for organizations is to set up a repository of information, such as in the format of a frequently asked questions (FAQs), such that users can obtain information for resolving their issues without requiring human assistance from the organizations. The repository may be accessed by various electronic means, such as webpages. The repository may even be searchable such that a user may find information related to one or more topics using a search function, and obtain relevant information based on the search. However, generating such a repository requires resources from the organization. Furthermore, the repository is valuable to the organization only when the content provided to the users is effective in resolving the issues. If the content is ineffective, the users may revert back to the traditional means of contacting the organizations to obtain resolution, which would increase the expenditure of human resources and related costs for the organization and could harm the reputation of the organization. Thus, there is a need for generating effective content for resolving potential users' issues in a cost-effective manner.

### BRIEF DESCRIPTION OF THE FIGURES

FIG. 1 is a block diagram illustrating an electronic transaction system according to an embodiment of the present disclosure;

FIG. 2 is a block diagram illustrating a content management module according to an embodiment of the present disclosure;

FIG. 3 illustrates an example data structure for metadata associated with a text data type according to an embodiment of the present disclosure;

FIG. 4 illustrates another example data structure for metadata associated with an audio data type according to an embodiment of the present disclosure;

FIG. 5 illustrates another example data structure for metadata associated with video data type according to an embodiment of the present disclosure;

FIG. 6 illustrates an extraction of different portions of a third-party content according to an embodiment of the present disclosure;

FIG. 7 illustrates an example of integrating third-party content into a primary content according to an embodiment of the present disclosure;

FIG. 8 illustrates an example of using the metadata of the primary content to assist in interacting with users according to an embodiment of the present disclosure;

FIG. 9 is a flowchart showing a process of integrating third-party content into primary content according to an embodiment of the present disclosure; and

FIG. 10 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for automatically enriching content provided by an organization (referred to as “primary content” herein) by compiling relevant third-party content and integrating the third-party content into primary content according to a structured format. As discussed above, organizations often provide content (also referred to herein as “content item(s)”) that is intended to provide product or service information to users and to assist users in resolving issues related to products offered by the organizations. In an example where the organization provides electronic and online payment transaction services, the products may include various software applications implemented within its mobile platform and/or web platform. The products may enable users to perform functionalities such as logging into and accessing user accounts, performing electronic and/or online payments to various parties such as merchants or another user, initiating a dispute of a transaction, initiating a transfer operation between funding accounts of a user, initiating a refund request for a transaction, and other payment-related functionalities. Some common issues that its users face may include payment decline (e.g., users inquiring why a payment transaction is declined), login fail (e.g., users inquiring why they cannot log into their user accounts), account reset (e.g., resetting passwords or other credentials for a user account), transaction disputes (e.g., how to file a dispute of a transaction), refund (e.g., how to request a refund from a transaction), transfer (e.g., how to initiate a fund transfer operation), and other issues. Thus, the organization may provide accessible content for assisting users in resolving these issues and for showing the users how to operate the products properly or address any issues or questions they have with the products.

In some embodiments, such content (primary content) may be provided through a webpage of the organization accessible by the public, such as a frequently asked question (FAQ) webpage of the website of the online service provider. The content may be organized by topics and sub-topics corresponding to different aspects and different potential issues experienced by the users. The webpage may enable the users to access relevant content by browsing through the various topics and/or submitting a search query. However, providing the content to the users in this manner is beneficial to the organization only to the extent that it is effective in resolving the issues of the users. If the users cannot get the assistance they need in resolving their issues from the content, the users will revert back to the traditional methods of contacting the organization (e.g., via phone, email, or chat, etc.), or worse yet, will abandon the products of the organization and move to a competitor's product, which will result in increasing expenditure and/or losses for the organization. In some embodiments, the effectiveness of a piece of content may be measured by a reversion rate that indicates a percentage of people who have viewed content related to a topic and subsequently communicate with the organization through one of the traditional means (e.g., by phone, e-mail, chat, etc.) to inquire about the topic.

While the organization may try to generate as much helpful information as possible for resolving known or potential issues experienced by users, the information generated by the organization may still be incomplete and/or ineffective. First, as the products offered by the organization become more sophisticated, the products may be used in a variety of different ways which increases the number of use case scenarios and issues with any one of the use case scenarios. Some of the use case scenarios may not even be foreseen by the organization itself, and thus the organization may be unable to provide content for issues related to those scenarios. Second, the content may be generated by computer software developers or other personnel of the organization, who may not be real-world users of the products and thus, may not have intimate knowledge of efficient ways to operate the products and resolve each of the issues or potential issues experienced by users.

On the other hand, real-world users (who may be third-parties to the organization) who use the products of the organization extensively may have knowledge about the operations and/or issues related to different products of the organization. These real-world users may provide helpful content related to the operations and/or issues of the different products. In fact, many real-world users have generated content (will be referred to as “third-party content”) that is accessible through different mediums with the intent to help other users. The third-party content may be in different formats from the primary content and may be accessed through different communication channels unrelated to the organization. For example, the third-party content may include articles with images (e.g., screenshots) published on a social media platform or a blog. The third-party content may also include video tutorials published on a video-streaming platform such as YouTube®. The third-party content may also include audio clips published in a podcast platform.

Some of the third-party content may provide information that is not available in the primary content generated by the organization (e.g., issues or resolutions to issues that were not known by the organization). Some of the third-party content may be more effective (e.g., more efficient in assisting users in resolving their issues) than the primary content provided by the organization. Thus, according to various embodiments of the disclosure, in order to improve the quality of the primary content provided by the organization, a content management system may actively and automatically enrich the primary content provided by the organization by compiling relevant third-party content and integrating the relevant third-party content into the primary content according to a structured format.

In some embodiments, the content management system may browse and search third-party content accessible over a network (e.g., the Internet) to identify which third-party content is relevant to the organization. For example, since the primary content provided by the organization is categorized under different topics and sub-topics, the content management system may search for third-party content that is relevant to the topics and/or the sub-topics. In some embodiments, the content management system may analyze each piece of third-party content that the system accesses over the network to determine whether the third-party content is relevant to the topics and/or the sub-topics. The content management system may perform keywords and/or linguistic analysis over the third-party content. When a third-party content includes multi-media data other than text (e.g., image, video, audio, etc.), the content management system may perform processing to the multi-media data, such as optical character recognition, image recognition, and/or voice recognition processing to the multi-media data before performing the keywords and/or linguistic analysis to the third-party content.

In some embodiments, instead of the entire third-party content, the content management system may determine that only one or more portions of the third-party content are relevant to the topics and/or sub-topics associated with the organization. For example, the content management system may determine only a portion of a third-party content (e.g., an article, a video clip, an audio clip) is relevant to a particular topic (or sub-topic). In some embodiments, the content management system may identify the relevant portion(s) of the third-party content based on one or more notations. For example, for a text-based third-party content, the content management system may use line numbers (e.g., lines 35-55), character counts (e.g., characters 500-754), or page numbers to identify which portion(s) of the third-party content is relevant to a topic or sub-topic. For a video or audio-based third-party content, the content management system may use an elapsed time (e.g., 3:30-5:13) to identify which portion(s) of the third-party content is relevant to a topic or sub-topic.

Thus, upon retrieving a third-party content, the content management system of some embodiments may generate additional data (e.g., metadata) to be associated with the retrieved third-party content. The metadata may include one or more topics (and/or sub-topics) to which the third-party content (or portion(s) of the third-party content) is relevant. The metadata may also include the identifiers for identifying the portion(s) of the third-party content that is relevant to the topic or sub-topic. The metadata may also include description of the third-party content, such as an author or presenter of the third-party content, a description of the content, one or more objects included in the content (e.g., screenshots, etc.), and other data.

In some embodiments, upon identifying a relevant third-party content, the content management system may determine a preliminary effectiveness of the third-party content. In some embodiments, the content management system may determine the preliminary effectiveness of the third-party content based on interaction data available on the medium through which the third-party content is accessed. For example, the medium (e.g., a blogging website, an audio/video streaming platform) may indicate interaction statistics such as a number of views, a number of comments, a number of positive feedbacks (e.g., likes or thumbs ups) and/or negative feedbacks (e.g., dislikes or thumbs downs), and the like. In some embodiments, the content management system may calculate a preliminary effective score based on the interaction data from the medium. Accordingly, the content management system may also include the effective score as part of the metadata for the third-party content.

In some embodiments, the content management system may combine different portions of one or more third-party content to generate a composite third-party content (e.g., a composite multi-media file). For example, the content management system may determine that both a first portion of a first third-party content and a second portion of a second third-party content are relevant to the same sub-topic. The content management system may generate a composite third-party content by combining the first portion of the first third-party content and the second portion of the second third-party content.

In some embodiments, the content management system may combine portions of different third-party content differently based on the formats and/or data types of the third-party contents. For example, when the two third-party contents are of the same formats (or same data type, such as both are articles, both are videos, both are audios, etc.), the content management system may combine the portions of third-party content by appending one portion to another portion. However, when the two third-party content are of different formats (e.g., one is a video and the other one is an audio), the content management system may superimpose one portion to another portion such that the presentation of the second portion of the second third-party content may supplement the presentation of the first portion of the first third-party content.

When the content management system determines that multiple different third-party content (that can be portions of third-party content or composite third-party content) are relevant to the same topic of sub-topic, the content management system may select one of the multiple third-party content (e.g., a first third-party content) to be integrated into the primary content. The content management system may access the primary content associated with the particular topic to which the first third-party content is relevant, and may integrate the first third-party content into the primary content. In some embodiments, the primary content may be associated with a structure, which may include different sections associated with different sub-topics of the particular topic. For example, the topic of “payment decline” may include different sub-topics such as “credit card expired,” “problems with card issuer,” “problems with one-time password,” and other sub-topics related to resolving the issues of “payment decline.” Thus, the primary content associated with the topic of “payment decline” may include different sections of sub-content that are associated with the different sub-topics, respectively.

In some embodiments, the content management system may generate, for each primary content, metadata for storing such information. The metadata of a primary content may include the topic of the primary content (e.g., topic=“payment decline”). The metadata of the primary content may also include information related to the different sections and their sub-topics, such as notations that indicate which portion(s) of the primary content is associated with which sub-topic. In one example where the primary content includes an article, the metadata may include notations that indicate which lines (or character counts) are associated with which sub-topics.

Thus, the content management system of some embodiments may first determine which sub-topic a first portion of the first third-party content is related to, based on the metadata associated with the first third-party content. The content management system may extract the first portion of the first third-party content. When the first third-party content is an article, extracting the first portion may include extracting all of the sub-content (which may include text, images, video/audio clips, etc.) within the first portion of the first third-party content. When the first third-party content is a video clip and/or an audio clip, extracting the first portion may include recording the first portion of the video clip and/or the audio clip. In some embodiments, the content management system may generate a new file (which may include a text file, a webpage document, a video file, an audio file, etc.), and may store the new file in a data storage associated with the content management system.

The content management system may then identify the section within the primary content that is associated with the sub-topic based on the metadata associated with the primary content. The content management system may integrate the first portion of the first third-party content into the section of the primary content associated with the sub-topic. For example, the content management system may insert the generated file into the section of the primary content. In some embodiments, the content management system may insert a reference of the generated file (e.g., a file name, a network location, etc.) into the section of the primary content. When the primary content is being rendered (e.g., upon a request such as an HTTP request from a user device), the inclusion of the reference may cause an application of the user device (e.g., the web browser) to download the new file associated with the third-party content and present the third-party content alongside (or within) the primary content.

In some embodiments, the content management system may determine whether the first third-party content includes other portion(s) associated with other topic(s) and/or sub-topic(s). For example, if the content management system determines that the first third-party content includes a second portion that is related to another sub-topic (e.g., one-time password expires) of “payment decline” topic, and may insert the second portion of the first third-party content into the section of the primary content associated with the one-time password expires subtopic in a similar manner as discussed herein.

If the content management system determines that the second portion of the first third-party content is related to another topic (e.g., a second topic), the content management system may access another primary content (e.g., a second primary content) associated with the second topic, and may integrate the second portion of the first third-party content into the second primary content in a similar manner as discussed herein.

In some embodiments, the content management system may determine a new sub-topic of the topic based on analyzing the first third-party content. For example, by analyzing the information associated with the first third-party content, the content management system may determine that the first third-party content is related to the “payment decline” topic, but is not related to any of the sub-topics under the “payment decline” topic. The content management system may then determine that the first third-party content includes information directed to a sub-topic that has not been covered by the primary content. The content management system may determine a label (e.g., a name, a description) for the new sub-topic based on words and phrases extracted from the first third-party content. The content management system may then modify the metadata associated with the primary content by adding a new section corresponding to the new sub-topic, and may integrate the first third-party content (or the portion of the first third-party content that is relevant to the new sub-topic) into the primary content.

In some embodiments, the content management system may update the metadata associated with the primary content when a third-party content is integrated into the primary content. For example, the content management system may insert a reference (e.g., a file name, a network location, etc.) of the new file associated with the third-party content (or a portion of the third-party content) into the metadata and associate the reference with the corresponding section of the primary content. This way, the content management system may track third-party content that have been integrated within the various primary content over time.

The content management system may continue to identify different third-party content for different topics (and sub-topics) (e.g., identify one that has the highest preliminary effectiveness score when multiple third-party contents are identified for the same topic/sub-topic), and may integrate the different third-party content into the primary content to enrich the primary content. When a primary content is being accessed (e.g., based on a request such as an HTTP request from a user device), the enriched primary content may be rendered on the user device and presented to a user. For example, when a request for content associated with a topic is received, the content management system may determine an integrated content for the topic based on the primary content and one or more third-party content that is related to the topic. The integrated content may include the primary content associated with the topic, and may also include the one or more third-party content (or references to files associated with the one or more third-party content) such that when the integrated content is rendered on the user device, both the primary content and the one or more third-party content are presented.

In some embodiments, the content management system may track the user interactions with the various primary content and third-party content. The content management system may determine the effectiveness of the third-party contents based on the user interactions with the third-party contents and subsequent interactions between the users and the online service providers. For example, the content management system may calculate an effectiveness score based on a reversion rate for each topic (and/or each sub-topic). The reversion rate represents a percentage of people who have viewed content related to a topic (or a sub-topic) and subsequently communicate with the organization through one of the traditional means (e.g., by phone, e-mail, chat, etc.) to inquire about the topic (or the sub-topic).

Thus, the content management system may determine effectiveness scores for various primary content and third-party content. In order to provide the most effective materials to the users, the content management system may test and evaluate different third-party content related to the same topic (and/or sub-topic) by integrating each of them into the primary content over different periods of time (e.g., 6-hour periods, 3-day periods, etc.). The content management system may determine effective scores of the various third-party content based on the reversion rates of the third-party content when the third-party content is being used with the primary content. The content management system may select a third-party content that has the highest effectiveness score to be used with the primary content after the testing period.

The content management system may continue to identify new third-party content that is relevant to the topics and sub-topics. When the content management system retrieves a new third-party content for the topic (or the sub-topic), the content management system may also test and evaluate the new third-party content to determine an effectiveness score for the new third-party content (e.g., by integrating the new third-party content into the primary content and make the integrated content accessible to the public for a testing period). If the effectiveness score for the new third-party content is higher than the effectiveness score for the third-party content currently integrated within the primary content, the content management system may replace the third-party content with the new third-party content. This way, the content management system may continue to enrich the content being provided to user by continuously retrieving and integrating third-party content into the primary content.

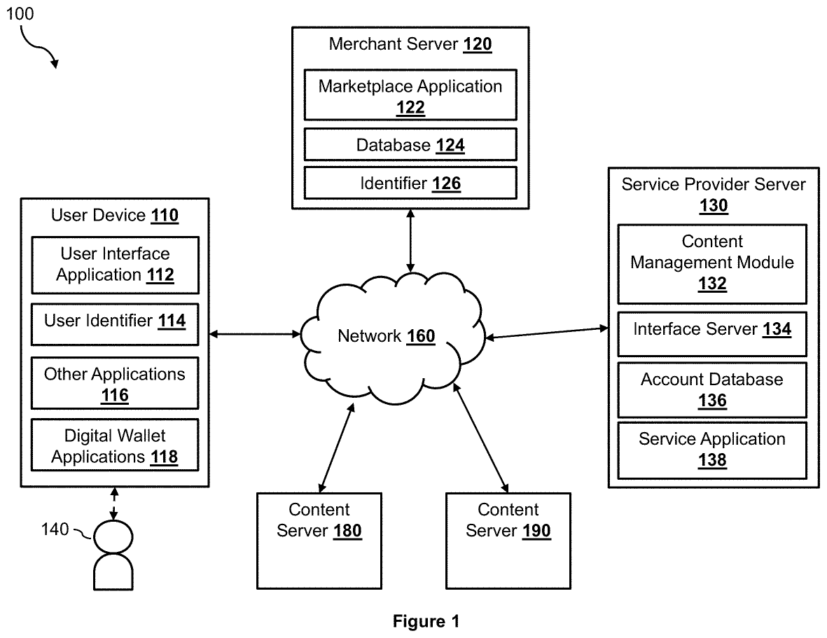

FIG. 1 illustrates an electronic transaction system 100, within which the content management system may be implemented according to one embodiment of the disclosure. The electronic transaction system 100 includes a service provider server 130, a merchant server 120, content servers 180 and 190, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

In various implementations, the user 140 is able to input data and information into an input component (e.g., a keyboard) of the user device 110. For example, the user 140 may use the input component to interact with the digital wallet application 112 (e.g., to add a new funding account, to provide information associated with the new funding account, to initiate an electronic payment transaction, etc.).

While only one user device 110 is shown in FIG. 1, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items, which may be made available to the user device 110 for viewing and purchase by the user.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items available for purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

Each of the content servers 180 and 190, in one embodiment, may be maintained by a third-party content platform that stores and hosts various third-party content generated by different third parties (e.g., not generated by the service provider server 130). The third-party content may be in different formats and/or data types. For example, one of the content servers 180 and 190 may include a video streaming platform that hosts videos generated by various third parties. One of the content servers 180 and 190 may include a blogging platform that hosts articles (that include text and/or image data) generated by various third parties. One of the content servers 180 and 190 may include an audio streaming platform that hosts audios generated by various third parties. The content servers 180 and 190 may provide access to this third-party content over the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also store a FAQ page and is configured to provide users access to different primary content generated by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user, access various services offered by the service provider server 130, and/or access various content (primary content of the service provider server 130), by generating HTTP requests directed at the service provider server 130.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 includes a content management module 132 that implements the content management system as discussed herein. The content management module 132 may be configured to enrich primary content accessible by the users of the service provider server 130. In some embodiments, the content management module 132 may store primary content that are associated with various topics intended to assist the users of the service provider server 130 in operating the products offered by the service provider server 130 and in resolving issues arise from the operations of the products. The content management module 132 may be configured to improve the quality of the primary content by integrating relevant third-party content into the primary contents. For example, the content management module 132 may retrieve, from third-party content servers such as the content servers 180 and 190, third-party content that is relevant to the topics and may selectively integrate some of the third-party content into the primary contents to enrich the primary content such that the content being served to the users would be more complete and more effective than the content before the integration.

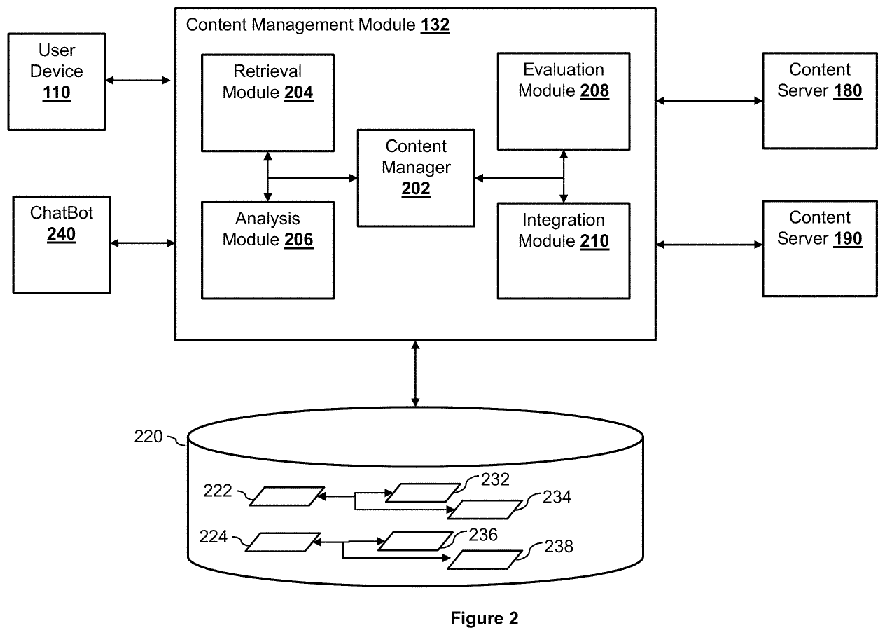

FIG. 2 illustrates a block diagram of the content management module 132 according to an embodiment of the disclosure. The content management module 132 includes a content manager 202, a retrieval module 204, an analysis module 206, an evaluation module 208, and an integration module 210. In some embodiments, the content management module 132 may store the primary content (e.g., primary content 222 and 224) in a data storage, such as a data storage 220. The primary content 222 and 224 are content that have been generated by the service provider server 130 (or agents associated with the service provider server 130). Each of the primary content may be associated with a specific topic. In some embodiments, the content manager 202 may use the analysis module 206 to analyze the primary content 222 and 224 to determine the topics associated with the primary content 222 and 224. The analysis may include keyword and/or linguistic analysis for determining an overall topic for each of the primary content 222 and 224. As discussed herein, the primary content may be generated to assist users in operating the products and resolving issues related to operating the products. Thus, based on the analysis on the primary content 222 and 224, the analysis module 206 may determine that the primary content 222 and 224 may be associated with different features of the products (e.g., “how to transfer money,” “how to reset passwords,” “how to initiate a dispute,” etc.) and/or different issues related to the products (e.g., “payment decline,” “login fails,” etc.).

Each of the topic associated with the primary content 222 and 224 may include multiple sub-topics. The sub-topics may also be derived from the primary content 222 and 224 themselves based on the analysis performed by the analysis module 206. For example, based on the keywords and linguistic analysis performed on a primary content, the analysis module 206 may divide the primary content into multiple sections, where each section corresponds to a sub-topic. The analysis module 206 may then perform additional keywords and/or linguistic analysis on each of the sections to derive a sub-topic for the corresponding section. In one example, the analysis module 206 may determine that the primary content 222 is associated with the topic of “payment decline.” When the primary content 222 is an article, the analysis module 206 may analyze the information within the primary content 222 in a sequential manner. Upon analyzing the information presented in the primary content 222 in a sequential manner, the analysis module 206 may determine that the primary content 222 includes three sections, where the first section (characters 101 to 200) is associated with a first sub-topic of “credit card expired,” the second section (characters 201-300) is associated with a second sub-topic of “contact bank,” and the third section (characters 301-400) is associated with a third sub-topic of “confirm bank.”

The analysis module 206 may perform a similar analysis on the primary content 224 to derive a topic and sub-topics associated with the primary content 224. When the primary content 224 has a temporal characteristic (e.g., a video clip, an audio clip, etc.), the analysis module 206 may perform the analysis in a temporal manner to divide the primary content 224 into multiple sections and derive sub-topics for the multiple sections.

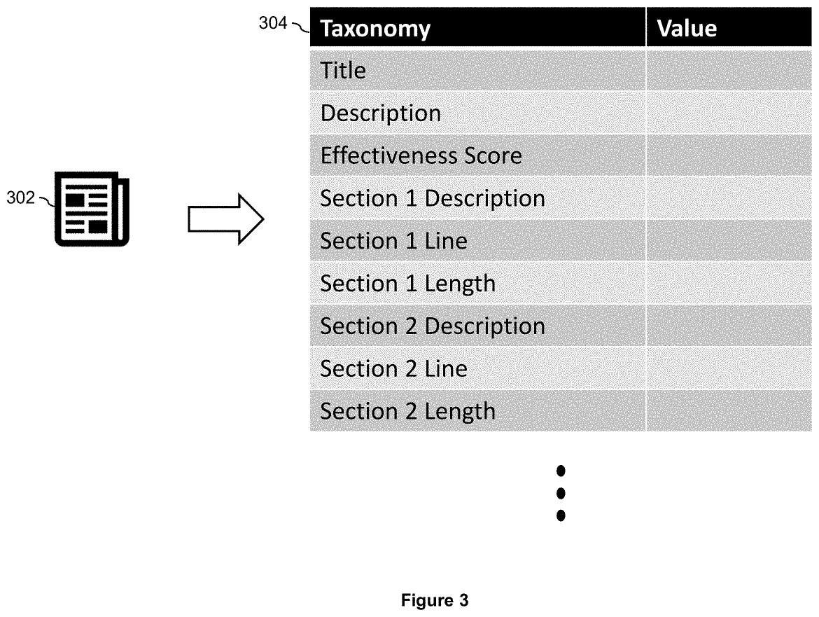

In some embodiments, the content manager 202 may generate metadata for each of the primary content 222 and 224 based on the information that the analysis module 206 derives and/or extracts from the primary content 222 and 224. In some embodiments, the content manager 202 may generate metadata in different data structure for content that is in different formats (e.g., articles, video, audio, etc.). FIG. 3 illustrates an example metadata structure 304 for an article content 302 that can be used by the content manager 202 for the primary content 222. As shown, the metadata 304 may include a title (an overall topic) of the content and a description. The metadata 304 may also include data associated with different sections within the content 302. For example, the metadata 304 may include data associated with a first section, including a description (e.g., a sub-topic) for the first section, and a notation that identifies the first section within the content 302 (e.g., starting line, length, etc.). The metadata 304 may include data associated with other sections (e.g., a second section, a third section, etc.) where applicable.

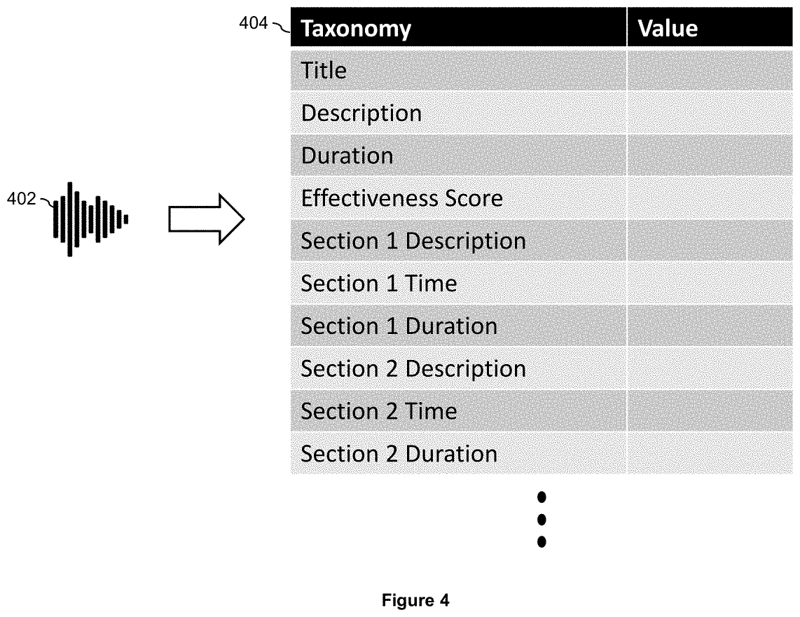

FIG. 4 illustrates an example metadata structure 404 for an audio content 402. Similar to the metadata 304, the metadata 404 may include a title (an overall topic) of the content and a description. In addition, the metadata 404 may also include a duration of the audio content 402. The metadata 404 may also include data associated with different sections within the audio content 402. For example, the metadata 404 may include data associated with a first section, including a description (e.g., a sub-topic) for the first section, and a notation that identifies the first section within the audio content 402. Unlike the metadata 304, the notation for the audio content 402 includes a starting time and a duration. The metadata 404 may include data associated with other sections (e.g., a second section, a third section, etc.) where applicable.

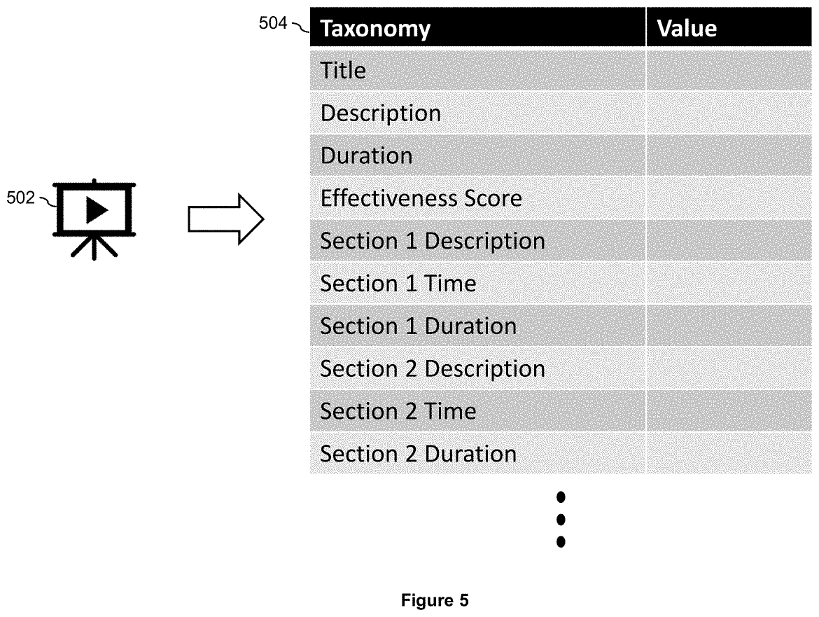

FIG. 5 illustrates an example metadata structure 504 for a video content 502. Similar to the metadata 404, the metadata 504 may include a title (an overall topic) of the content, a description, and a duration. The metadata 504 may also include data associated with different sections within the video content 502. For example, the metadata 504 may include data associated with a first section, including a description (e.g., a sub-topic) for the first section, and a notation that identifies the first section within the video content 502. Similar to the metadata 504, the notation for the video content 502 includes a starting time and a duration. The metadata 504 may include data associated with other sections (e.g., a second section, a third section, etc.) where applicable.

Referring back to FIG. 2, thus, the content manager 202 may generate metadata for the primary content 222 and 224 according to the format (or data type) associated with the primary content 222 and 224, using the information derived and/or extracted by the analysis module 206. In some embodiments, the metadata associated with the primary content 222 and 224 may be used by the retrieval module 204 to retrieve third-party content that is relevant to the topics (and sub-topics) associated with the primary content 222 and 224, which will be discussed in more detail below.

In some embodiments, the evaluation module 208 may determine the effectiveness of each of the primary content 222 and 224 based on the user interactions with the primary content 222 and 224. For example, the evaluation module 208 may monitor and track user interactions with the primary content 222 and 224. The evaluation module 208 may detect that a user (e.g., the user 140) has accessed a primary content of the service provider server 130 over the network 160 (e.g., by accessing a network address associated with the primary content, etc.). The evaluation module 208 may monitor user interactions between the user and the primary content, such as a duration of viewing the primary content, which section(s) of the primary content has been viewed, etc. The evaluation module 208 may then determine whether the user initiates communication with the service provider server 130 via a different means (e.g., via phone, e-mail, and/or chat) within a time threshold (e.g., 10 minutes, 30 minutes, a day, etc.) after accessing the primary content. The evaluation module 208 may determine that the same user initiates the communication with the service provider server 130 after viewing the primary content based on the same user device that is used to view the primary content and to initiate the communication, or the same user account that is linked to the user devices used to view the primary content and to initiate the communication. Thus, in some embodiments, the evaluation module 208 may calculate the effectiveness score for the primary content based on the reversion rate of the primary content. In some embodiments, once the effectiveness score for a primary content is determined, the content manager 202 may store the effectiveness score in the metadata associated with the primary content.

The content management module 132, in some embodiments, is configured to retrieve, from third-party content servers such as the content servers 180 and 190, third-party content (e.g., third-party content 232-238) that is relevant to the topics and/or the sub-topics. For example, the retrieval module 204 may determine one or more keywords for each topic associated with the primary content. The keywords may be extracted from the primary content themselves. In a particular example, the retrieval module 204 may parse through the content in the primary content 222 and determine words and/or phrases that appear in the primary content 222 having a frequency above a threshold (e.g., 5 times, 10 times, etc.). The one or more keywords for the primary content 222, which is related to the topic of “payment decline,” may include “payment decline,” “payment not accepted,” “cannot pay,” “payment error,” and other words or phrases.

The retrieval module 204 may then use the keywords to identify third-party content that is relevant to the topic. In some embodiments, the retrieval module 204 may include a web crawler that is configured to crawl through the Internet and access various third-party content. In some embodiments, the retrieval module 204 may be configured to search for third-party content only on designated websites (designated third-party content platforms). The retrieval module 204 may access the third-party content, analyze the third-party content, and determine whether the third-party content is relevant to any of the topics associated with the primary content 222 and 224. For example, the retrieval module 204 may perform keywords and/or linguistic analysis over the third-party content. When a third-party content includes multi-media data other than text (e.g., image, video, audio, etc.), the retrieval module 204 may perform processing to the multi-media data, such as optical character recognition, image recognition, and/or voice recognition processing to the multi-media data before performing the keywords and/or linguistic analysis to the third-party content.

If the retrieval module 204 determines that the third-party content is relevant to any one (or at least one) of the topics associated with the primary content 222-224, the retrieval module 204 may retrieve the third-party content, and may store the third-party content in the data storage 220. For example, the retrieval module 204 may retrieve third-party content 232-238 from the content servers 180 and 190 based on the analysis performed on the third-party content accessible from the content servers 180 and 190.

Upon retrieving the third-party content 232-238, the analysis module 206 may perform a second analysis on the third-party content 232-238. While the first analysis performed by the retrieval module 204 on the third-party content is more cursory for determining whether a third-party content is relevant to at least one of the topics associated with the primary content 222-224, the second analysis that is performed by the analysis module 206 on the retrieved third-party contents 232-238 is more thorough and detailed. For example, the second analysis is performed by the analysis module 206 to determine which topic(s) a third-party content is relevant to, and which sub-topic(s) of the topic(s) the third-party is relevant to. In some embodiments, the analysis module 206 may perform a linguistic analysis on a third-party content to determine a set of topics to which the third-party content is relevant to. In this example, the analysis module 206 may determine that the third-party content 232 and 234 is relevant to a topic associated with the primary content 222, and that the third-party content 236-238 is relevant to a topic associated with the primary content 224.

In addition, the analysis module 206 may determine, based on the linguistic analysis, which sub-topic(s) of the topic(s) the third-party content is relevant to. As discussed herein, each topic associated with the primary content 222-224 may include multiple sub-topics. For example, the topic of “payment decline” may include different sub-topics such as “credit card expired,” “problems with card issuer,” “problems with one-time password,” and other sub-topics related to resolving the issues of “payment decline.” The analysis module 206 may derive keywords associated with each of the sub-topics, and perform analysis on different portions of the third-party content using the derived keywords. The analysis module 206 may then identify portion(s) of the third-party content for one or more sub-topics of the topic associated with a primary content. For example, the analysis module 206 may determine that a first portion of the third-party content 232 is relevant to a first sub-topic (e.g., credit card expired) of the topic (e.g., payment decline), while a second portion of the third-party content 232 is relevant to a second sub-topic (e.g., problems with card issuer). The analysis module 206 may also determine that a portion of the third-party content 234 is relevant to a third sub-topic (e.g., problems with one-time password) of the topic (payment decline). The analysis module 206 may continue to analyze the remaining third-party content (e.g., the third-party content 236 and 238), and identify sub-topics and portions of the third-party content that is relevant to the sub-topics.

In some embodiments, the analysis module 206 may determine a new sub-topic of the topic based on analyzing a third-party content. For example, by analyzing the information associated with the third-party content, the analysis module 206 may determine that the third-party content is related to the “payment decline” topic, but is not related to any of the sub-topics under the “payment decline” topic. The analysis module 206 may then determine that the third-party content includes information directed to a sub-topic that has not been covered by the primary content (e.g., the primary content 222). The analysis module 206 may determine a label (e.g., a name, a description) for the new sub-topic based on words and phrases extracted from the first third-party content. The analysis module 206 may then modify (update) the metadata associated with the primary content 222 by adding a new section corresponding to the new sub-topic, and may associate third-party content (or the portion of the first third-party content that is relevant to the new sub-topic) to the new sub-topic.

In some embodiments, the content manager 202 may also generate metadata for each of the third-party content 232-238 based on the information derived and/or extracted by the analysis module 206. The metadata generated by the content manager 202 for the third-party content 232-238 may be similar to the metadata generated for the primary content 222-224, depending on the formats or data types of the third-party content 232-238. For example, the content manager 202 may generate metadata for a third-party content according to the format of the metadata 304 when the third-party content is an article. The content manager 202 may generate metadata for a third-party content according to the format of the metadata 404 when the third-party content is an audio clip. The content manager 202 may generate metadata for a third-party content according to the format of the metadata 504 when the third-party content is a video clip. The metadata of the third-party content may enable the integration module 210 to determine which portion(s) of each third-party content is relevant to which sub-topic, and to integrate the portions of the third-party content into the primary contents accordingly.

In some embodiments, the evaluation module 208 may also determine a preliminary effectiveness score for each of the third-party content 232-238 based on user interaction data associated with the third-party content 232-238. For example, the content servers 180 and 190 that host the third-party content 232-238 (which can be a blogging website, an audio/video streaming platform) may indicate interaction statistics associated with the third-party content 232-238. The evaluation module 208 may obtain, from the content servers 180 and 190, the interaction statistics associated with the third-party content 232-238, which may include a number of views, a number of comments, a number of positive feedbacks (e.g., likes or thumbs ups) and/or negative feedbacks (e.g., dislikes or thumbs downs), and the like. In some embodiments, the evaluation module 208 may calculate a preliminary effective score based on the interaction data from the content servers 180 and 190. Accordingly, the content manager 202 may also include the preliminary effective score as part of the metadata for the third-party content.

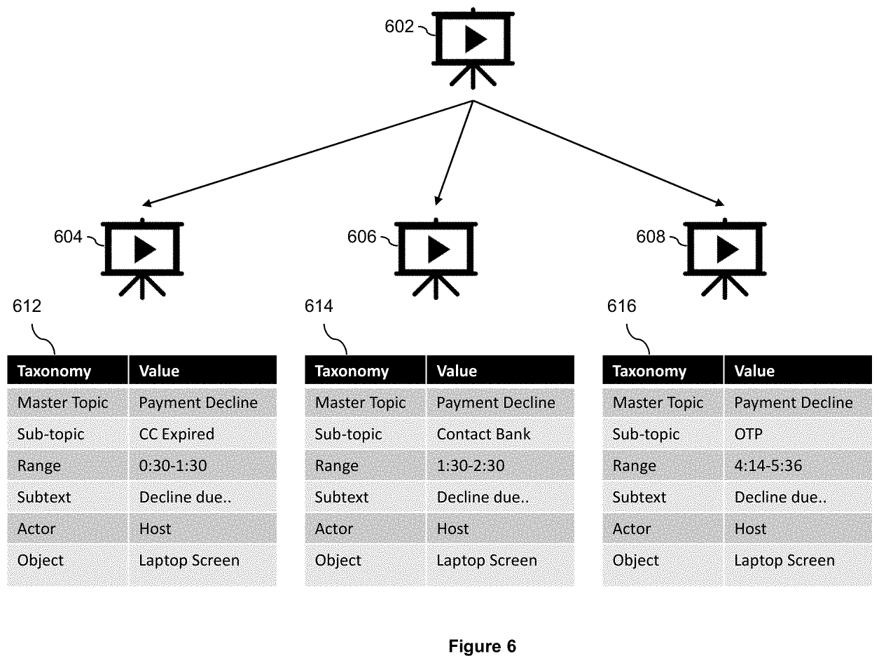

In some embodiments, in addition to storing information associated with the different portions of the third-party contents in the metadata of the third-party content, the integration module 210 of the content management module 132 may generate a new data file for each portion of the third-party content and generate new metadata for each of the new data files. FIG. 6 illustrates the generation of new files based on different portions of a third-party content 602. In the example shown in FIG. 6, the third-party content 602 is a video content, and the analysis module 206 may determine that the video content 602 is relevant to a particular topic (e.g., the “payment decline” topic). The analysis module 206 may further determine that three different portions of the third-party content 602 are relevant to three different sub-topics of the “payment decline” topic, respectively. For example, the analysis module 206 may determine that a first portion (from time 0:30 to 1:30) of the third-party content 602 is relevant to the sub-topic “credit card expired,” a second portion (from time 1:30 to 2:30) of the third-party content 602 is relevant to the sub-topic “contact bank,” and a third portion (from time 4:14 to 5:36) of the third-party content 602 is relevant to the sub-topic “one-time password.” The content manager 202 may insert the information associated with the different portions of the third-party content 602 into the metadata associated with the third-party content 602.

In some embodiments, the content manager 202 may also generate new metadata for each of the new files 604-608. For example, the content manager 202 may generate metadata 612 for the video file 604, generate metadata 614 for the video file 606, and generate metadata 616 for the video file 608. The metadata may include information that represents the third-party content 602 from which the portion is extracted (e.g., a file name of the third-party content 602, a network address that links to the third-party content 602, etc.), the topic that the video file is relevant to (e.g., payment decline, etc.), the sub-topic that the video file is relevant to (e.g., credit card expires, etc.), a notation that identifies the portion of the content with the third-party content 602 (e.g., line numbers, character numbers, time duration, etc.), and other information associated with that portion of content, such as an author/actor within the portion of content, and other objects being presented within the portion of content (e.g., screenshots, etc.).

As shown, the metadata 612 includes a master topic field representing the topic that the video file 604 is relevant to, a sub-topic field representing the sub-topic that the video file 604 is relevant to, a range field identifying the portion within the third-party content 602 associated with the video file 604, a subtext field representing a description of the video file 604, an actor field representing the author or the host of the video file 604, an object field indicating what object(s) is present in the video file 604. Each of the metadata 614 and 616 also has similar data fields as the metadata 612 to represent information associated with the video files 606 and 608, respectively. Although not shown, each of the metadata 612, 614, and 616 may include other data fields such as a link to the third-party content 620 from which the video file is extracted, an effective score, and other information.

The example illustrated above describes generating the new third-party content files based on portions from the same third-party content 602. In some embodiments, a new third-party content file may be generated based on portions of different third-party content. For example, the integration module 210 may determine that both a first portion of a first third-party content (e.g., the third-party content 232) and a second portion of a second third-party content (e.g., the third-party content 234) are relevant to the “credit card expires” sub-topic. The integration module 210 may generate a new third-party content file by combining the first portion of the first third-party content and the second portion of the second third-party content.

In some embodiments, the integration module 210 may combine portions of different third-party content differently based on the formats and/or data types of the third-party content. For example, when the two third-party content 232 and 234 are of the same format (or same data type, such as both are articles, both are videos, both are audios, etc.), the integration module 210 may combine the portions of third-party content by appending one portion to another portion. However, when the two third-party content 232 and 234 are of different format (e.g., the third-party content 232 is a video and the third-party content 234 is an audio), the integration module 210 may superimpose one portion to another portion such that the presentation of the second portion of the second third-party content may supplement the presentation of the first portion of the first third-party content. For example, when the third-party content 232 is a video and the third-party content 234 is an audio, the integration module 210 may superimpose the audio data associated with the second portion of the third-party content 234 into the video data associated with the first portion of the third-party content 232.

In some embodiments, the integration module 210 may integrate the relevant third-party content into the primary content. For each topic, the integration module 210 may determine various third-party content (or portions of the third-party content) that are relevant to the topic. The integration module 210 may then group the various third-party content based on the sub-topics associated with the topic. When only one third-party content (or a portion of a third-party content) is relevant to a sub-topic, the integration module 210 may integrate the third-party content into the primary content associated with the topic.

When multiple different third-party content (that can be portions of third-party content or combined portions of different third-party content) are relevant to the same sub-topic, the integration module 210 may select one of the multiple third-party content to be integrated into the primary content. In some embodiments, the integration module 210 may randomly select, from the multiple third-party content that are relevant to the sub-topic, a third-party content to be integrated within the primary content. In some embodiments, the integration module 210 may select the third-party content to be integrated within the primary content based on the preliminary effective score (e.g., selecting one with the highest effective score).

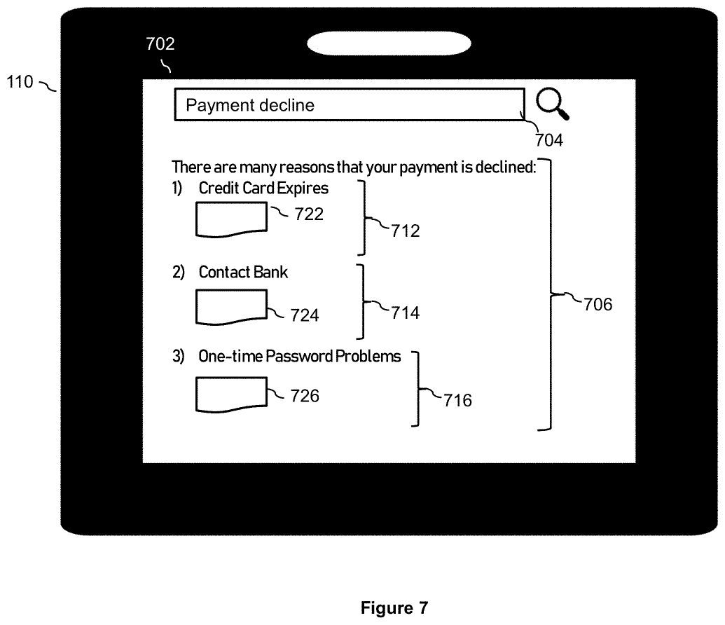

FIG. 7 illustrates integrating various third-party content into a primary content 706. In this example, the primary content 706 is associated with the payment decline topic. To integrate third-party content into the primary content 706, the integration module 210 may access the metadata of the primary content 706. The metadata indicates to the integration module 210 the different sub-topics under the payment decline topic, and how the different sub-topics are organized within the first primary content. In this example, the metadata may indicate that the primary content 706 is an article, where a first section 712 (e.g., lines 15-45) of the primary content 706 is associated with a first sub-topic (e.g., credit card expires) of the payment decline topic, a second section 714 (e.g., lines 50-78) of the primary content 706 is associated with a second sub-topic (e.g., contact bank), and a third section 716 (e.g., lines 83-100) of the primary content 706 is associated with a third sub-topic (e.g., one-time passwords problems).

The integration module 210 may determine that the third-party content 722-726 are relevant to the sections 712-716 of the primary content 706. Each of the third-party content 722-726 may include an entire third-party content that has been retrieved from one of the content servers 180 and 190, a portion of a third-party content that has been retrieved from one of the content servers 180 and 190, or a combined third-party content that is combined based on portions of different third-party content that have been retrieved from one or more of the content servers 180 and 190. The integration module 210 may integrate the third-party content selected for the first sub-topic (e.g., the third-party content 722) into the first section 712 of the primary content 706. For example, the integration module 210 may insert the third-party content 722 or a reference to the third-party content (e.g., a network address) into the first section 712 of the primary content. Similarly, the integration module 210 may integrate the other third-party content 724 and 726 into the second section 714 and the third section 716 of the primary content 706, respectively by inserting the third-party content 724 and 726 or references to the third-party content 724 and 726 into the second section 714 and the third section 716 of the primary content 706.

After integrating the third-party content 722, 724, and 726 into the primary content 706, the content manager 202 may present the integrated content (including the primary content 706 and the third-party content 722, 724, and 726) to a user. For example, the user 140 may use the user device 110 to access the primary content 706. In some embodiments, the user 140 may access the primary content 706 via a user interface 702 (e.g., a web site) associated with the service provider server 130. The service provider server 130 may provide a FAQ page having a search function. The user 110 may provide one or more keywords in a search bar 704 presented on the user interface 702. Based on the keywords, the content manager 202 may determine a topic (e.g., the payment decline topic), and may provide the integrated content that combines the primary content 706 and the third-party content 722-726 to the user 140.

In some embodiments, the evaluation module 208 may track the user interactions with the various primary content 222 and 224 and their linked third-party content 232-238. The evaluation module 208 may determine the effectiveness of the third-party content based on the user interactions with the third-party content and subsequent interactions between the users and the service provider server 130. For example, the evaluation module 208 may calculate an effectiveness score based on a reversion rate for each topic and each sub-topic. The reversion rate represents a percentage of people who have viewed content related to a topic (or a sub-topic) and subsequently communicate with the organization through one of the traditional means (e.g., by phone, e-mail, chat, etc.) to inquire about the topic (or the sub-topic).

Thus, the evaluation module 208 may determine effectiveness scores for various third-party content based on their respective reversion rates. In some embodiments, when multiple third-party content are relevant to the same sub-topic, the content manager may evaluate the different third-party content by integrating the different third-party content into the primary content at different time period. For example, when multiple third-party content are determined to be relevant to the subtopic associated with the first section 712, the integration module 210 may select a first third-party content to be integrated into the first section 712 of the primary content 706 during a first period of time. The evaluation module 208 may evaluate the effectiveness (e.g., may generate an effective score) of the first third-party content based on user interactions with the first third-party content within the primary content 706. The integration module 210 may then integrate a second third-party content that is relevant to the sub-topic in place of the first third-party content during a second period of time. Similarly, the evaluation module 208 may evaluate the effectiveness of the second third-party content during the second period of time. The integration module 210 may continue to replace the third-party content in the first section 712 of the primary content 706 and evaluate their effectiveness until all of the third-party content that are determined to be relevant to the sub-topic have been evaluated.

The integration module 210 may then select, among the multiple third-party, a particular third-party content to be integrated into the primary content 706 based on the evaluations. In some embodiments, the integration module 210 may select the particular third-party content having the highest effective score. In some embodiments, if the content manager 202 determines that the highest effective score of the particular third-party content is still below the effective score of the primary content before the integration, the content manager 202 may remove the particular third-party content from the primary content. Otherwise, the integration module 210 may keep the particular third-party content integrated with the primary content 706 until a better (e.g., a more effective) third-party content that is relevant to the sub-topic is detected. For example, the retrieval module 204 may continue to crawl the Internet and identify third-party content that is relevant to the topics and the sub-topics associated with the primary content 222-224, as new third-party content may be generated and published from time to time. When a new third-party content that is relevant to the sub-topic is identified, the integration module 210 may test the new third-party content by integrating the new third-party content in the first section 712 of the primary content 706 in place of the particular third-party content for a period of time and evaluate the effectiveness of the new third-party content. If the effectiveness of the new third-party content is lower than the particular third-party content (e.g., the third-party content currently being integrated within the first section 712 of the primary content 706), the integration module 210 may revert back to the particular third-party content for the first section 712 of the primary content 706. However, if the effectiveness of the new third-party content is higher than the particular third-party content, the integration module 210 may replace the particular third-party content with the new third-party content. This way, the content management module 132 may continue to enrich the primary content of the service provider server 130 being provided to user by continuously retrieving and integrating effective third-party content into the primary contents.

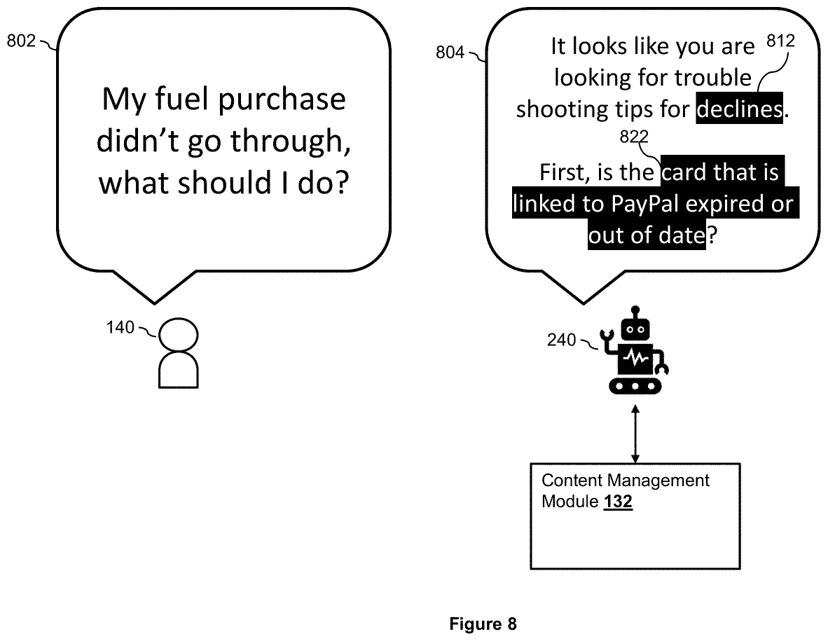

As shown in the examples illustrated above, the metadata structures generated for the primary content and the third-party content may help the content management module 132 in enriching the primary content of the service provider server 130. In some embodiments, the metadata structure may also be used to assist the service provider server 130 in interacting with the users. FIG. 8 illustrates an example of using the metadata of the primary content and the third-party content to assist the service provider server 130 in interacting with the users. In FIG. 8, a user (e.g., the user 140) has initiated a chat session with a chatbot 240 of the service provider server 130. The chatbot 240, in some embodiments, includes software programs configured to automatically interact with users in natural language. The users, through the chat interface, may communicate with the chatbot 240 by submitting messages to the chatbot 240. The chatbot 240 may be configured to analyze the messages, determine an intent of the users based on the analysis, and determine an appropriate response to the users. In some embodiments, the chatbot 240 may use the metadata of the primary content and/or the third-party content to determine the response for the users.

In this example, the user transmitted a message 802 “my fuel purchase didn't go through, what should I do?” to the chatbot 240 through the chat session. The chatbot 240 may, through an analysis of the message 802, determine an intent of the user 140 is associated with the payment decline topic. The chatbot 240 may then access the primary content and its metadata associated with the payment decline topic. By parsing and analyzing the metadata associated with the primary content (e.g., the primary content 222), the chatbot 240 may determine the various sub-topics of the payment decline topic, which may include the “credit card expires” sub-topic, the “contact bank” sub-topic, the “one-time password problems” sub-topic. As such, the chatbot 240 may generate a response 804 to the message 802 based on the metadata of the primary content 222. For example, the chatbot 240 may generate the response 804 to prompt the user 140 for additional information to determine which sub-topic is relevant to the user 140's inquiry. In this example, the generated response 804 includes the phrase 812 that is derived from the payment decline topic, to confirm with the user 140 that the inquiry of the user 140 is related to the topic “payment decline.” The generated response 804 may also include the phrase 822 derived from the first sub-topic “credit card expires” from the “payment decline” topic, to prompt the user 140 for additional information related to the payment decline, such that the chatbot 240 can determine whether the inquiry of the user 140 is related to the first sub-topic “credit card expires” or other sub-topics.

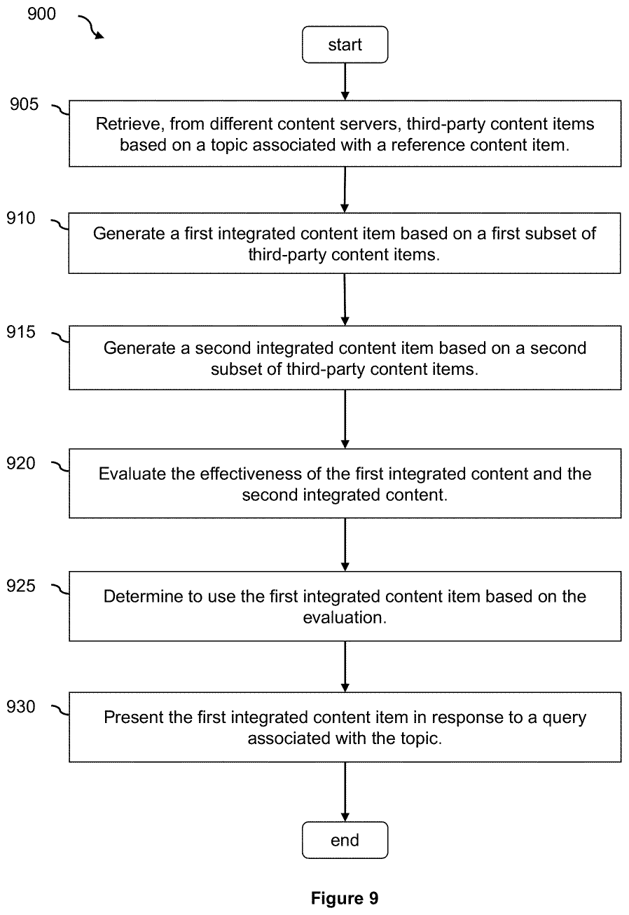

FIG. 9 illustrates a process 900 for enriching primary contents according to various embodiments of the disclosure. In some embodiments, at least a portion of the process 900 may be performed by the content management module 132. The process 900 begins by retrieving (at step 905), from different content servers, third-party content items based on a topic associated with a reference content item. For example, the retrieval module 204 may access various content servers, such as the content servers 180 and 190, over the network 160. The retrieval module 204 may identify third-party content hosted by the content servers 180 and 190 based on keywords and phrases derived from the metadata associated with the primary content 222 and 224.

The process 900 then generates (at step 910) a first integrated content item based on a first subset of third-party content items. For example, after retrieving third-party content (e.g., the third-party content 232-238) that are relevant to the topics associated with the primary content 222-224, the analysis module 206 may determine which sub-topic each of the third-party content is relevant to. In some embodiments, the content manager 202 may extract one or more portions from a third-party content that correspond to different sub-topics. The content manager 202 may generate new files for the extracted portions and generate metadata for the third-party content and their portions. Multiple third-party content may be relevant to the same sub-topic. In this case, the integration module 210 may select a first third-party content to be integrated into a primary content during a first period of time. In some embodiments, the integration module 210 may select the first third-party content based on the preliminary effectiveness of the multiple third-party content. The integration module 210 may integrate the first third-party content into the primary content to generate the first integrated content.

The process 900 then generates (at step 915) a second integrated content item based on a second subset of third-party content items. The integration module 210 may generate a second third-party content from the multiple third-party content that is relevant to the topic associated with the primary content. The integration module 210 may integrate the second third-party content into the primary content to generate the second integrated content.

At step 920, the process 900 evaluates the effectiveness of the first integrated content and the second integrated content. For example, the content manager 202 may cause the first integrated content to be accessible by users during a first period of time (e.g., 3 days, 6 weeks, etc.). When a user requests to access the primary count during the first period of time, the content manager 202 may present the first integrated content to the user. The evaluation module 208 may evaluate the effectiveness of the first integrated content based on user interaction with the first integrated content and/or a reversion rate associated with the users who view the first integrated content.

The content manager 202 may then cause the second integrated content to be accessible by users during a second period of time (e.g., the next 3 days, the next 6 weeks, etc.). When a user requests to access the primary count during the second period of time, the content manager 202 may present the second integrated content to the user. The evaluation module 208 may evaluate the effectiveness of the second integrated content based on user interaction with the second integrated content and/or a reversion rate associated with the users who view the second integrated content.

The process 900 then determines (at step 925) to use the first integrated content item based on the evaluation. For example, the content manager 202 may determine that the first integrated content is more effective than the second integrated content based on the evaluations (e.g., the first integrated content has a lower reversion rate than the second integrated content). Thus, the content manager 202 may determine to use the first integrated content for the primary content.

The process 900 then presents (at step 930) the first integrated content item in response to a query associated with a topic. For example, the service provider server 130 may provide a user interface (e.g., the user interface 702) to a user, which enables the user to search for information associated with different topics. Based on the search phrase received from the input field 704, the content manager 202 may determine a topic. When the content manager 202 determines that the topic is associated with the primary content, the content manager 202 may present the first integrated content to the user.

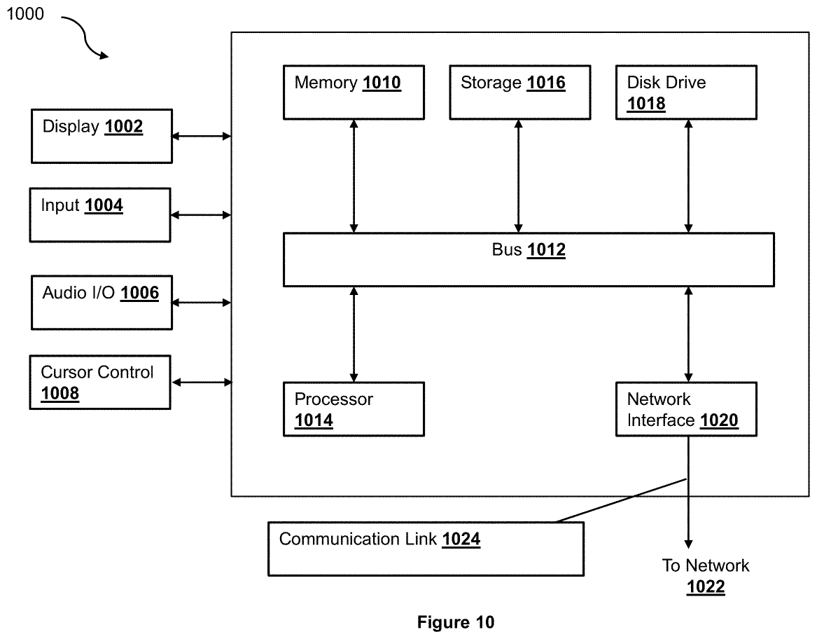

FIG. 10 is a block diagram of a computer system 1000 suitable for implementing one or more embodiments of the present disclosure, including the service provider server 130, the merchant server 120, the data source servers 180 and 190, and the user device 110. In various implementations, the user device 110 may include a mobile cellular phone, personal computer (PC), laptop, wearable computing device, etc. adapted for wireless communication, and each of the service provider server 130, the merchant server 120, and the data source servers 180 and 190 may include a network computing device, such as a server. Thus, it should be appreciated that the devices 110, 120, 130, 180, and 190 may be implemented as the computer system 1000 in a manner as follows.

The computer system 1000 includes a bus 1012 or other communication mechanism for communicating information data, signals, and information between various components of the computer system 1000. The components include an input/output (I/O) component 1004 that processes a user (i.e., sender, recipient, service provider) action, such as selecting keys from a keypad/keyboard, selecting one or more buttons or links, etc., and sends a corresponding signal to the bus 1012. The I/O component 1004 may also include an output component, such as a display 1002 and a cursor control 1008 (such as a keyboard, keypad, mouse, etc.). The display 1002 may be configured to present a login page for logging into a user account or a checkout page for purchasing an item from a merchant. An optional audio input/output component 1006 may also be included to allow a user to use voice for inputting information by converting audio signals. The audio I/O component 1006 may allow the user to hear audio. A transceiver or network interface 1020 transmits and receives signals between the computer system 1000 and other devices, such as another user device, a merchant server, or a service provider server via network 1022. In one embodiment, the transmission is wireless, although other transmission mediums and methods may also be suitable. A processor 1014, which can be a micro-controller, digital signal processor (DSP), or other processing component, processes these various signals, such as for display on the computer system 1000 or transmission to other devices via a communication link 1024. The processor 1014 may also control transmission of information, such as cookies or IP addresses, to other devices.

The components of the computer system 1000 also include a system memory component 1010 (e.g., RAM), a static storage component 1016 (e.g., ROM), and/or a disk drive 1018 (e.g., a solid-state drive, a hard drive). The computer system 1000 performs specific operations by the processor 1014 and other components by executing one or more sequences of instructions contained in the system memory component 1010. For example, the processor 1014 can perform the token sharing functionalities described herein according to the process 900.

Logic may be encoded in a computer readable medium, which may refer to any medium that participates in providing instructions to the processor 1014 for execution. Such a medium may take many forms, including but not limited to, non-volatile media, volatile media, and transmission media. In various implementations, non-volatile media includes optical or magnetic disks, volatile media includes dynamic memory, such as the system memory component 1010, and transmission media includes coaxial cables, copper wire, and fiber optics, including wires that comprise the bus 1012. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1000. In various other embodiments of the present disclosure, a plurality of computer systems 1000 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A method comprising:
retrieving, by one or more hardware processors, a plurality of third-party content items from a plurality of content servers based on a topic associated with a reference content item;
evaluating, by the one or more hardware processors, an effectiveness of each of the plurality of third-party content items based on indications of user interactions with the plurality of third-party content items;
selecting, by the one or more hardware processors, a subset of third-party content items from the plurality of third-party content items based on the evaluating;
integrating, by the one or more hardware processors, the subset of third-party content items into the reference content item; and
in response to a query associated with the topic submitted by a client device, providing, by the one or more hardware processors, the integrated reference content item to the client device.

2. The method of claim 1, further comprising determining, based on the reference content item, a plurality of sections associated with the topic.

3. The method of claim 2, further comprising:
deriving metadata for each of the subset of third-party content item; and
associating each of the subset of third-party content item with a section in the plurality of sections based on the derived metadata, wherein the subset of third-party content items is integrated into different portions of the reference content item based on the associated sections.

4. The method of claim 1, wherein the reference content data is associated with a first format, and wherein at least a first third-party content item in the subset of third-party content items is associated with a second format different from the first format.

5. The method of claim 1, further comprising generating a composite multi-media content item based on two or more portions of the subset of third-party content time, wherein the integrating comprises integrating the composite multi-media content item with the reference content item.

6. The method of claim 1, wherein the subset of third-party content items is a first subset of third-party content items, wherein the integrated reference content item is a first integrated reference content item, and wherein the method further comprises:
selecting a second subset of third-party content items from the plurality of third-party content items based on the evaluating; and
generating a second integrated reference content item based on integrating the second subset of third-party content items into the reference content item.

7. The method of claim 6, further comprising:
determining a first effectiveness score for the first subset of third-party content items based on first user interactions with the first integrated reference content item;
determining a second effectiveness score for the second subset of third-party content items based on second user interactions with the second integrated reference content item;
determining that the second effectiveness score is higher than the first effectiveness score; and
in response to determining that the second effectiveness score is higher than the first effectiveness score, replacing the first integrated reference content item with the second integrated reference content item.

8. A system comprising:
a non-transitory memory; and
one or more hardware processors coupled to the non-transitory memory and configured to read instructions from the non-transitory memory to cause the system to perform operations comprising:
obtaining a plurality of third-party content items from a plurality of content servers based on a topic associated with a reference content item;
selecting a subset of third-party content items from the plurality of third-party content items based on levels of relevance of the plurality of third-party content items with respect to the topic;
generating a composite multi-media content item by integrating a first portion of a first content item from the subset of third-party content item with a second portion of a second content from the subset of third-party content item; and
in response to a query associated with the topic submitted by a client device, presenting the reference content item and the composite multi-media content item on the client device.

9. The system of claim 8, wherein the operations further comprise:
deriving corresponding metadata for each third-party content item in the plurality of third-party content items; and
determining, for each third-party content item in the plurality of third-party content item, a level of relevance with respect to the topic based on the corresponding metadata.

10. The system of claim 9, wherein the deriving the corresponding metadata comprises:
dividing a third-party content item into a plurality of portions of content; and
determining a description associated with each portion of content in the plurality of portions of content.

11. The system of claim 10, wherein the operations further comprise determining a time duration and a timestamp associated with each portion of content in the plurality of portions of content.

12. The system of claim 10, wherein the operations further comprise:
determining that the first portion of the first third-party content item and the second portion of the second third-party content item share a common description; and
selecting the first portion of the first third-party content item and the second portion of the second third-party content item for generating the composite multi-media content item based on the determining that the first portion and the second portion share the common description.

13. The system of claim 8, wherein the composite multi-media content item comprises a video clip.

14. The system of claim 8, wherein the first portion of the first third-party content item comprises a video data, and wherein the second portion of the second third-party content item comprises audio data, wherein the integrating the first portion of the first third-party content item with the second portion of the second third-party content item comprises merging the audio data with the video data.

15. A non-transitory machine-readable medium having stored thereon machine-readable instructions executable to cause a machine to perform operations comprising:
receiving, from a user device, a query through a first communication channel;
determining, from a plurality of topics associated with a plurality of primary content items of an online service provider, a particular topic;
accessing an integrated content item based on the particular topic, the integrated content item created by integrating one or more third-party content items into a particular primary content item associated with the particular topic; and
presenting the integrated content item on the user device;

16. The non-transitory machine-readable medium of claim 15, wherein the operations further comprise:
detecting a communication initiated by a user associated with the user device through a second communication channel;
determining that the communication is related to the particular topic; and
updating an effectiveness score representing an effectiveness of the integrated content item based on the detected communication.

17. The non-transitory machine-readable medium of claim 16, wherein the one or more third-party content items is first one or more third-party content item, and wherein the operations further comprise:
modifying the integrated content item by replacing the first one or more third-party content item with second on or more third-party content item based on the updated effectiveness score of the integrated content item; and
in response to receiving a second query associated with the particular topic, presenting the modified integrated content item.

18. The non-transitory machine-readable medium of claim 16, wherein the second communication channel is one of a phone channel, an email channel, or an online chat session.

19. The non-transitory machine-readable medium of claim 15, wherein the query is received through a website of the online service provider.

20. The non-transitory machine-readable medium of claim 15, wherein the web site comprises a search bar for submitting queries.
